(19) United States
(12) Patent Application Publication
(10) Pub. No.: US 2026/0286162 A1
(43) Pub. Date: Sep. 24, 2026

(54) ANTIMICROBIAL COMPOSITION AND PEST-PROOF ANTIMICROBIAL LIGHTING COMPRISING SAME

(71) Applicant: MTC CO., LTD., Gwacheon-si, Gyeonggi-do (KR)

(72) Inventors: Gwi Yeol MOON, Gwacheon-si (KR); Bong Sik PARK, Seoul (KR); Jun Sang PARK, Seoul (KR)

(73) Assignee: MTC CO., LTD., Gwacheon-si, Gyeonggi-do (KR)

(21) Appl. No.: 19/474,656

(22) PCT Filed: Jun. 7, 2023
(86) PCT No.: PCT/KR2023/007745

§ 371 Date: Oct. 10, 2025

(30) Foreign Application Priority Data
Apr. 12, 2023 (KR) 10-2023-0048431
May 24, 2023 (KR) 10-2023-0066976

(51) Int. Cl. C09D 101/02; C08K 5/3435; C09D 5/14; C09D 7/61; C09D 7/63

(52) U.S. Cl. CPC C09D 101/02; C08K 5/3435; C09D 5/14; C09D 7/61; C09D 7/63

(57) ABSTRACT

The present invention relates to a pest-proof and antimicrobial composition and a pest-proof lighting comprising same. Particularly, the present invention provides a pest-proof and antimicrobial composition, wherein a pest-proof and antimicrobial composition comprising metal powder, sea marine stone, nanocellulose, and ultrapure water is manufactured, and the pest-proof and antimicrobial composition is coated on an LED lamp having the color temperature of 2000K to 3000K and the wavelength band of 510 to 700 nm. Particularly, the present invention provides a pest-proof and antimicrobial composition, wherein a pest-proof and antimicrobial composition comprising metal powder, sea marine stone, nanocellulose, and ultrapure water is manufactured, and the pest-proof and antimicrobial composition is coated on an LED lamp having the color temperature of 2000 K to 3000 K and the wavelength band of 510 to 700 nm.

### TECHNICAL FIELD

The present invention relates to an antimicrobial composition and a pest-proof and antimicrobial lighting including the same.

### BACKGROUND ART

In general, lighting apparatuses include various lighting apparatuses such as LED lights, fluorescent lights, incandescent lights or halogen lights, and are essentially installed in offices, homes, reading rooms, schools, hospitals, or industrial facilities, so as to be used for limited functions including illuminating the darkness, such as illuminating the interior. Among these lighting apparatuses, the LED lighting apparatuses are mainstream in terms of luminous efficiency and energy saving for efficient power use.

Meanwhile, when ventilation is insufficiently performed in indoor spaces, such as offices, reading rooms, study accommodations, or homes, installed with various lighting apparatuses including LED lighting apparatuses, indoor humidity increases to maintain a humid environment and causes bad odors and bacteria to breed, thereby threatening the health of residents. In modern society, in addition to bacteria, diseases such as sick building syndrome tend to prevalently occur due to volatile organic compounds such as formaldehyde, xylene, toluene, benzene, or acetone.

Further, a lot of bugs may be attracted to outdoor lighting in the summer, and pest-proof lightings may be used to prevent the bugs, however, may also have limitations.

Accordingly, researches are needed on lightings that simultaneously have deodorizing properties and pest-proof effects.

### DISCLOSURE

### Technical Problem

The present invention provides an air purification system easily installed and maintained to provide a lighting apparatus containing an antimicrobial composition having antimicrobial and antiviral effects and volatile organic compound-deodorizing and removing effects in a living space.

In addition, the present invention provides a lighting device capable of suppressing pests attracted to the light of the lighting device.

### Technical Solution

The present invention provides an antimicrobial and pest-proof composition including metal powder, sea marine stone, nanocellulose, and water, wherein the metal powder includes one or more selected from gold, silver, titanium, copper, zinc, vanadium, iron, platinum, nickel, aluminum, magnesium, and calcium powder, and the sea marine stone includes 20 to 40 wt % of SiO₂, 10 to 25 wt % of Al₂O₃, 2 to 10 wt % of SnO₂, 2 to 10 wt % of Fe₂O₃, 0.1 to 2 wt % of MgO, 1 to 2 wt % of K₂O, 0.3 to 2 wt % of Na₂O, 20 to 40 wt % of TiO₂, 0.3 to 3 wt % of ZnO, 0.01 to 0.05 wt % of MnO, and 0.0005 to 0.005 wt % of P₂O₅.

According to one aspect of the present invention, the antimicrobial composition may include 40 to 60 parts by weight of sea marine stone, 1 to 10 parts by weight of metal powder, and 40 to 60 parts by weight of nanocellulose based on 100 parts by weight of the water. According to one aspect of the present invention, the water may be ultrapure or distilled water. According to one aspect of the present invention, the antimicrobial composition may further include picaridin.

According to one aspect of the present invention, the antimicrobial composition may further include 0.01 to 10 parts by weight of picaridin based on 100 parts by weight of the water. According to one aspect of the present invention, the metal powder may have an average particle diameter of 1 nm to 200 nm.

According to one aspect of the present invention, the marine stone may have a powder form and have an average particle size of 1 nm to 200 nm.

According to one aspect of the present invention, the antimicrobial and pest-proof composition may be coated on an LED lighting to provide an antimicrobial and pest-proof lighting. According to one aspect of the present invention, the LED lighting may have a color temperature range of 2,000 K to 6,000 K.

According to one aspect of the present invention, the LED lighting may have a color temperature range of 2,000 K to 3,000 K.

According to one aspect of the present invention, the LED lighting may emit a light wavelength obtained by removing a wavelength band of 300 nm to 500 nm.

According to one aspect of the present invention, the LED lighting may emit a light wavelength of 510 nm to 700 nm.

According to one aspect of the present invention, the LED lamp may be any one selected from a bulb type, a street lamp, a solar street lamp, floodlight, a solar floodlight, a ceiling light, a downlight, a searchlight, a horizon light, a multi-light pendant, a stand light, a full light, a wall lamp, a kitchen lamp, a living room lamp, a flat edge lamp, a square light, a circular room lamp, a cross-line lamp, an I-line lamp, a square sensor lamp, a circular sensor lamp, a circular ceiling downlight, an oval ceiling downlight, an underground lamp, a parking lot lighting lamp, a compatible LED lamp, a PL fixture, a short type ball bulb, a long type ball bulb, a studio button lamp, a square button lamp, a cross lamp, a long stand lamp, a mood lamp, a factory lamp, a desk stand lamp, a slim surface lighting, a bathroom lamp, a sink lamp, a shoe rack lamp a flat slim bezel edge, a square floodlight, a traffic light, a sensor lamp, a ceiling downlight lamp, a recessed floodlight, a signboard lamp, a flat panel lighting, a surface lighting, a ship floodlight, a landscape lighting, a factory floodlight, a tunnel lamp, a waterproof surface lighting flat lamp, an emergency downlight, a gas station LED lighting, an emergency guide lamp, a light for high-temperature and high-humidity environments, an emergency flat lamp, a sports lighting, a floodlight and landscape lamp, a parking lot lamp, a moisture-proof lamp, a parking lamp, a security street lamp, a crosswalk floodlight, a street and garden lamp, a security lamp, a tree light and a car headlight.

### Advantageous Effects

The antimicrobial composition according to the present invention has the deodorizing effect for volatile organic compounds generated from various building materials and the antimicrobial and antiviral effects in living spaces, so that quality air can be provided within the living spaces. In addition, the LED lamp coated with the antimicrobial composition of the present invention is used, so that deodorizing effect can be implemented and the attraction of pests can be suppressed.

### DESCRIPTION OF DRAWINGS

FIG. 1 shows images of pest attraction according to pest-proof antimicrobial lighting and general commercial LED lighting.

FIG. 2 shows image A of a wavelength band of the pest-proof antimicrobial lighting and image B of the general commercial LED lighting.

FIG. 3 is an image of a certificate on completely blocking blue light.

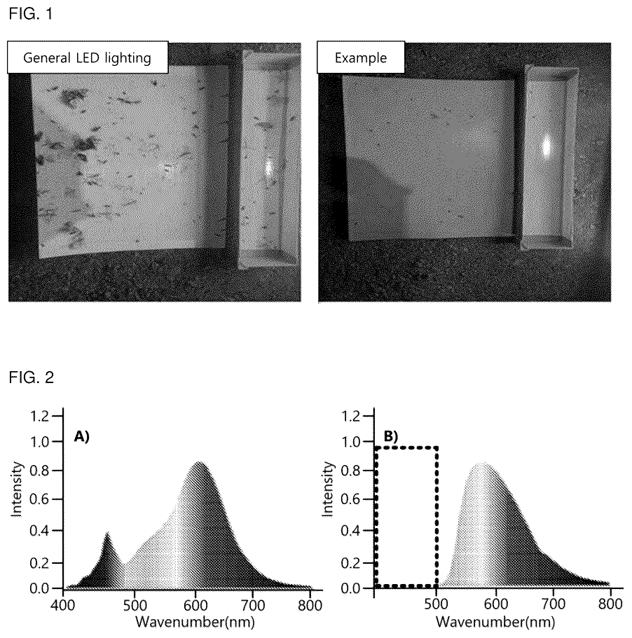

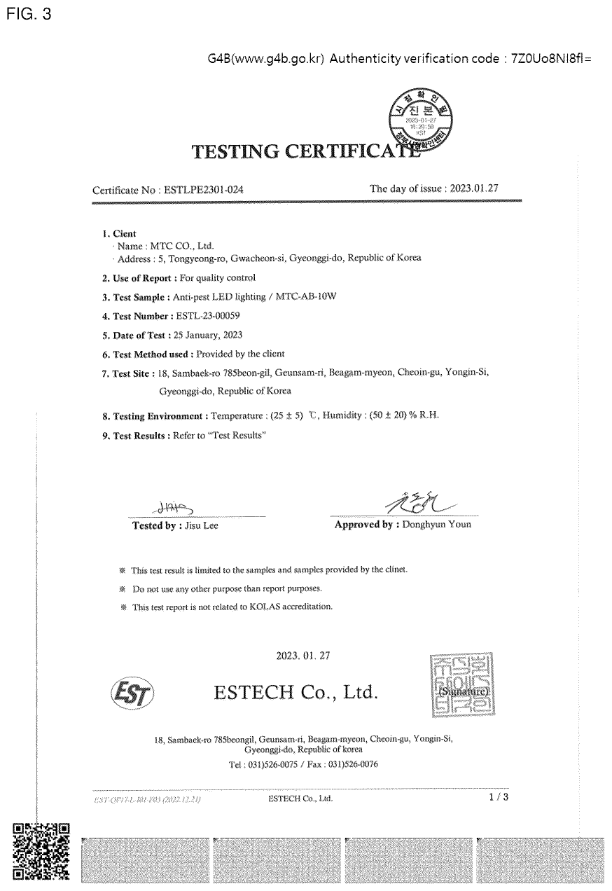

### BEST MODE

### Mode for Invention

Hereinafter, the present invention will be described in more detail through the embodiments or the examples including the accompanying drawings. However, the following the embodiments or the examples are only the reference for describing the present invention in detail, and the present invention is not limited thereto and may be implemented in various forms.

In addition, unless otherwise defined, all technical and scientific terms have the same meaning as commonly understood by one of those having ordinary skill in the art. The term used in the description of the present invention is only for the purpose of effectively describing particular embodiments and is not intended to limit the present invention.

In addition, the singular forms used in the specification and the appended claims are intended to include the plural forms as well, unless the context clearly indicates otherwise.

In addition, when one component “includes” some elements, it does not exclude other elements, but may further include the other elements, unless particularly stated otherwise.

The present invention provides a pest-proof and antimicrobial composition including metal powder, sea marine stone, nanocellulose, and water, wherein the metal powder includes one or more selected from gold, silver, titanium, copper, zinc, vanadium, platinum, nickel, iron, aluminum, magnesium and calcium powder, and the sea marine stone includes 20 to 40 wt % of SiO₂, 10 to 25 wt % of Al₂O₃, 2 to 10 wt % of SnO₂, 2 to 10 wt % of Fe₂O₃, 0.1 to 2 wt % of MgO, 1 to 2 wt % of K₂O, 0.3 to 2 wt % of Na₂O, 20 to 40 wt % of TiO₂, 0.3 to 3 wt % of ZnO, 0.01 to 0.05 wt % of MnO, and 0.0005 to 0.005 wt % of P₂O₅.

The pest-proof and antimicrobial composition includes metal powder, marine stone, nanocellulose and water, thereby not only having antimicrobial and deodorizing effects, but also maximally inhibiting the access of pests when the antimicrobial composition is applied to wallpaper, lighting or the like, so that a comfortable living environment can be established. The metal powder refers to powder including one or more selected from gold, silver, titanium, copper, zinc, vanadium, platinum, nickel, iron, aluminum, magnesium, and calcium. Specifically, the metal powder may be powder including one or more selected from gold, silver, titanium, copper, zinc, and magnesium. Specifically, the metal powder may be powder including one or more selected from silver, titanium, copper, and zinc. Specifically, the metal powder may be powder composed of silver, titanium, copper, and zinc.

In addition, the metal powder may be in the form of metal hydroxide or metal oxide, however, the present invention is not limited thereto.

The metal powder refers to a mixture of each metal powder, and for example, silver, titanium, copper, and zinc powder may be mixed in an equal content.

According to one aspect of the present invention, the metal powder may have an average particle size of 1 nm or more, 2 nm or more, 5 nm or more, 10 nm or more, or 20 nm or more; 200 nm or less, 150 nm or less, 100 nm or less, 50 nm or less, or 30 nm or less; 1 nm to 200 nm; 2 nm to 5 nm; 20 nm to 30 nm; or 50 nm to 150 nm, however, the present invention is not limited thereto.

The sea marine stone includes 20 to 40 wt % of SiO₂, 10 to 25 wt % of Al₂O₃, 2 to 10 wt % of SnO₂, 1 to 10 wt % of Fe₂O₃, 0.1 to 2 wt % of MgO, 1 to 3 wt % of K₂O, 0.3 to 2 wt % of Na₂O, 20 to 40 wt % of TiO₂, 0.3 to 3 wt % of ZnO, 0.01 to 0.05 wt % of MnO, and 0.0005 to 0.005 wt % of P₂O₅; and specifically, may include 30 to 40 wt % of SiO₂, 20 to 25 wt % of Al₂O₃, 7 to 10 wt % of SnO₂, 1.7 to 5 wt % of Fe₂O₃, 0.8 to 2 wt % of MgO, 1.5 to 2 wt % of K₂O, 1 to 2 wt % of Na₂O, 30 to 40 wt % of TiO₂, 1.5 to 3 wt % of ZnO, 0.03 to 0.05 wt % of MnO, and 0.001 to 0.003 wt % of P₂O₅, however, the present invention is not limited thereto.

According to one aspect of the present invention, the marine stone may have a powder form and have an average particle size of 1 nm or more, 2 nm or more, 5 nm or more, 10 nm or more, or 20 nm or more; 200 nm or less, 150 nm or less, 100 nm or less, 50 nm or less, or 30 nm or less; 1 nm to 200 nm; 2 nm to 5 nm; 10 nm to 30 nm; or 50 nm to 150 nm, however, the present invention is not limited thereto.

The nanocellulose may be cellulose nanofiber (CNF) or cellulose nanocrystal, however, the present invention is not limited thereto.

The cellulose nanofiber may have a diameter of 5 nm to 100 nm and a length of 300 nm to 100 μm, however, the present invention is not limited thereto. In addition, the cellulose nanocrystal may have a diameter of 2 nm to 20 nm and a length of 100 nm to 600 nm, however, the present invention is not limited thereto.

According to one aspect of the present invention, the water may be ultrapure water or distilled water, however, the present invention is not limited thereto.

According to one aspect of the present invention, the antimicrobial composition may include 40 to 60 parts by weight of sea marine stone, 1 to 10 parts by weight of metal powder, and 40 to 60 parts by weight of nanocellulose based on 100 parts by weight of the water.

The antimicrobial composition is mixed in the above contents, so that antimicrobial and deodorizing effects can be excellent when the antimicrobial composition is coated on a base material, and particularly, the phenomenon of attracting bugs and the like can be suppressed.

According to one aspect of the present invention, the pest-proof and antimicrobial composition may further include picaridin.

The picaridin is also called icaridin and refers to an environmentally friendly raw material certified by the World Health Organization (WHO).

The pest-proof and antimicrobial composition further includes picaridin, so that antimicrobial and deodorizing effects can be excellent and particularly, the phenomenon of attracting bugs and the like can be suppressed.

According to one aspect of the present invention, the pest-proof and antimicrobial composition may further include 0.01 to 10 parts by weight of picaridin based on 100 parts by weight of the water, however, the present invention is not limited thereto.

The manufactured pest-proof and antimicrobial composition is not limited to a type of base material when it can be applied thereon, and specifically, may be applied to walls, ceilings, floors, fabrics, lighting devices, and the like.

Particularly, when the pest-proof and antimicrobial composition is applied to a lighting device, bugs and the like that may be attracted by light of the lighting device can be repelled.

The lighting device is not limited to one that can irradiate light to a predetermined area, such as direct lighting that includes a light source to directly irradiate light or indirect lighting that indirectly irradiates light through reflected light from an external light source, and may refer to conventional lighting modules, lighting apparatuses, lighting, and the like. For specific example, lighting apparatuses to which a lighting such as a pest-proof and antimicrobial lighting is applied may be used, wherein the pest-proof and antimicrobial lighting includes any one selected from an LED lighting, a fluorescent lamp, an incandescent lamp, a ceiling light, a downlight, a spotlight, a searchlight, a horizon light, a multi-light pendant, a light stand, a chandelier, a full light, a wall lamp, a kitchen lamp, a living room lamp, a flat edge lamp, a square room lamp, a circular room lamp, a cross-line lamp, an I-line lamp, a square sensor lamp, a circular sensor lamp, a circular ceiling downlight lamp, an oval ceiling downlight lamp, an underground lamp, a parking lot lighting lamp, a fluorescent parallel lamp (FPL), a parallel lamp (PL) fixture, a short type ball bulb, a long type ball bulb, a studio button lamp, a square button lamp, a cross lamp, a long stand lamp, a mood lamp, a factory lamp, a desk stand lamp, a slim surface lighting, a bathroom lamp, a sink lamp, a shoe rack lamp a flat edge future, a flat slim bezel edge, a square floodlight, a traffic light, a sensor lamp, a ceiling downlight lamp, a recessed floodlight, a signboard lamp, a flat panel lighting, a surface lighting, a ship floodlight, a landscape lighting, a factory floodlight, a tunnel lamp, a waterproof surface lighting flat lamp, an emergency downlight, a gas station LED lighting, an emergency guide lamp, a light for high-temperature and high-humidity environments, an emergency flat lamp, a sports lighting, a floodlight and landscape lamp, a parking lot lamp, a moisture-proof lamp, a parking lamp, a security strect lamp, a crosswalk floodlight, a street and garden lamp, a security lamp, a tree lamp, and a car headlight. Specifically, LED lighting apparatuses may be used, but the present invention is not limited thereto.

According to one aspect of the present invention, the LED lighting apparatus may include any one selected from a bulb type, a bar type, a street light type, and a flood light type.

According to one aspect of the present invention, an antimicrobial and pest-proof lighting obtained by coating the antimicrobial and pest-proof composition on an LED lighting may be provided. The antimicrobial and pest-proof composition is applied to the LED lighting, so that the antimicrobial and deodorizing effects can be implemented and the phenomenon of attracting bugs to light can be suppressed.

According to one aspect of the present invention, the LED lighting may have a color temperature range of 2,000 K to 6,000 K, and specifically 2,000 K to 3,000 K. When the color temperature range of the LED lighting is 3000 K or less, yellow light may be emitted, and when it is above 3000 K, white light may be emitted.

When the color temperature range is satisfied between 2,000 K and 3,000 K, the number of bugs attracted to the light emitted from the LED may be further reduced.

According to one aspect of the present invention, the LED lighting is used to satisfy the color temperature range and have a wavelength band of 510 nm to 700 nm, so that the number of bugs attracted to the light may be significantly reduced.

FIG. 4 is a table showing wavelength bands of the pest-proof and antimicrobial lighting, wavelength bands of the general commercial LED lighting, and removal rates of blue light. The conventional LED lighting is used to have a wavelength band of 300 nm to 700 nm. In the present invention, the LED lighting may be blocked in a wavelength band of 300 nm to 500 nm to effectively suppress the pest attraction, and specifically, may have a wavelength band of 510 nm to 700 nm.

When the LED lighting having the wavelength band of 510 nm to 700 nm, the bug-repelling effect may be excellent. Particularly, when the pest-proof and antimicrobial composition is applied onto the LED lighting having the wavelength band of 510 nm to 700 nm, the antimicrobial, deodorizing and pest-proof effects can be further improved.

Specifically, a manufacturing process of the LED may proceed sequentially through an Epitaxial (Epi) wafer manufacturing, chip production, packaging, module and the like. The Epi wafer may be an SiC substrate, however, the present invention is not limited thereto.

In addition, another aspect of the manufacturing process of the LED may include a packaging process, and the packaging process may be a process including a step of connecting manufactured chips and leads and packaging the connected chips and leads to allow light to be emitted to the outside as much as possible; and a module step of using an LED completed in the packaging to attaching the LED onto a predetermined frame. However, the present invention is not limited thereto.

In addition, according to the present invention, in order to implement a blue light-blocked LED having a wavelength of 300 nm to 500 nm, the LED may be used as an excitation light source, and a fluorescent material for exhibiting a yellow color (510 nm to 700 nm) of yttrium aluminum garnet (YAG) may be used to the excitation light source. However, this is merely an example, and the present invention is not limited thereto when it can remove a wavelength band of 300 nm to 500 nm.

Particularly, the antimicrobial composition according to one aspect of the present invention is applied to the LED lamp, so that a photocatalytic effect may be generated in addition to the pest-proof effect. The photocatalytic effect refers to an effect of reducing atmospheric pollutants such as NOx and SOx into water and carbon dioxide, and the present invention is not limited to the general photocatalytic effect.

Hereinafter, the present invention will be described in more detail based on Examples and Comparative Examples. However, the following Examples and Comparative Examples are only examples for describing the present invention in more detail, and the present invention is not limited by the following Examples and Comparative Examples.

### [Deodorization Characteristic Test]

After construction in living rooms, rooms, and bathrooms of a newly built apartment complex, the air purification ability is measured based on the detection tube method (Gastech product GSP-200 detection tube 91PL & 122P).

In addition, changes in emission amounts of total volatile organic compounds (TVOC) and formaldehyde (HCHO) from 3.5T of domestically produced medium-density fiberboard (MDF) and domestically produced high-density fiberboard (HDF) commonly used in construction are measured on days 1, 7, 14 and 21.

### [Removal Efficiency of Blue Light]

Spectra according to wavelengths of the pest-proof and antimicrobial lighting of the present invention and the general LED lighting are shown in Table 1 below.

TABLE 1

| MTC Pest-proof LED 3,000K | | | General LED lighting 3,000K | | | | |
|---|---|---|---|---|---|---|---|
| Wavelength | | AD | Wavelength | | AD | Blue light removal rate | |
| (nm) | Spectrum | Value | (nm) | Spectrum | Value | AD Value deviation | |
| 380 | 0.0015 | 68 | 380 | 0.0026 | 71 | 3 | 0.05 |
| 385 | 0.0012 | 70 | 385 | 0.0046 | 115 | 45 | 0.65 |
| 390 | 0.0009 | 70 | 390 | 0.0145 | 326 | 256 | 3.68 |
| 395 | 0.001 | 75 | 395 | 0.0255 | 637 | 563 | 7.55 |
| 400 | 0.0012 | 83 | 400 | 0.0207 | 602 | 519 | 6.22 |
| 405 | 0.0021 | 112 | 405 | 0.0277 | 872 | 760 | 6.81 |
| 410 | 0.0041 | 180 | 410 | 0.0577 | 1960 | 1780 | 9.88 |
| 415 | 0.0079 | 317 | 415 | 0.0882 | 3250 | 2933 | 9.26 |
| 420 | 0.0143 | 569 | 420 | 0.0931 | 3700 | 3131 | 5.51 |
| 425 | 0.025 | 970 | 425 | 0.1061 | 4281 | 3311 | 3.41 |
| 430 | 0.0428 | 1616 | 430 | 0.1419 | 5678 | 4062 | 2.51 |
| 435 | 0.0741 | 2634 | 435 | 0.1788 | 6841 | 4207 | 1.6 |
| 440 | 0.1296 | 4776 | 440 | 0.2061 | 8291 | 3516 | 0.74 |
| 445 | 0.2304 | 9017 | 445 | 0.2672 | 11338 | 2321 | 0.26 |
| 450 | 0.39 | 15709 | 450 | 0.3864 | 17002 | 1293 | 0.08 |

### [Experiment on Pest Attraction Prevention]

An antimicrobial composition is applied to 1 m×1 m of a white cloth and then dried to produce a coated cloth, the number of attracted bugs is counted by spreading the coated cloth on a wall of a building outdoors and shining the cloth using a lamp.

### Example 1

A mixed composition is prepared by mixing 51.17 parts by weight of marine sea stone, 3.93 parts by weight of mixed metal powder of silver, titanium, copper and zinc, and 51.98 parts by weight of nanocellulose based on 100 parts by weight of water. The mixed composition is wet ground using a Rotate Mill (RRG-100) device, and the raw material is milled for 50 minutes to have an average particle size of 25 nm, thereby preparing the antimicrobial composition. A deodorizing characteristic test is performed on the prepared antibacterial composition, and the results are shown in Tables 2 to 3. In addition, an experiment of pest attraction prevention is performed on the prepared antimicrobial composition and resulted in Table 4.

### Example 2

A mixed composition is prepared by mixing 51.17 parts by weight of sea marine stone, 3.93 parts by weight of mixed metal powder of silver, titanium, copper and zinc, 51.98 parts by weight of nanocellulose, and 1.23 parts by weight of picaridin based on 100 parts by weight of water. The mixed composition is wet ground using a Rotate Mill (RRG-100) device, and the raw material is milled for 50 minutes to have an average particle size of 25 nm, thereby preparing the antimicrobial composition. An experiment of pest attraction prevention is performed on the prepared antimicrobial composition and resulted in Table 4.

TABLE 2

| Organic | Concentration before | Concentration after | Removal |
|---|---|---|---|
| compound | construction (μg/m³) | construction (μg/m³) | rate |
| formaldehyde | 100 | 26 | 74% |
| toluene | 1,300 | 260 | 80% |
| xylene | 4,250 | 858 | 80% |
| ethylbenzene | 1,430 | 286 | 80% |

TABLE 3

| | |
|---|---|
| TVOC (mg/m² 2 h) | HCHO(mg/m² 2 h) |

| | Uncoated | Coated | Uncoated | Coated |
|---|---|---|---|---|
| | specimen | specimen | specimen | specimen |
| Day 1 | 0.118 | 0.051 | 0.060 | 0.003 |
| Day 7 | 0.132 | 0.023 | 0.046 | 0.004 |
| Day 14 | 0.120 | 0.021 | 0.048 | 0.012 |
| Day 21 | 0.109 | 0.016 | 0.061 | 0.008 |

TABLE 4
Location: Jigok-myeon, Seosan-si,
South Chungcheong Province, Korea

| | Number of | Expected | |
|---|---|---|---|
| Item | bugs | effect | Test conditions |
| Cloth not coated with | About 200 | None | Time: 21:00- |
| antimicrobial composition | or more | | 22:00 |
| Example 1 | About 100 | Good | Temperature: |
| | | | 27° C. |
| Example 2 | About 30 | Very good | Humidity: 66% |
| | | | Wind: 3 m/s |

### Example 3

The antimicrobial composition of Example 2 is applied to a surface of an LED lighting having a color temperature range of 3000 K and a wavelength band of 510 nm to 700 nm, and dried to manufacture the pest-proof antimicrobial lighting. Then, the pest-proof and antimicrobial lighting is installed in each location, the number of bugs flocking to the lighting is measured and compared to that of the general lighting, and the results are listed in Table 5 below. In this regard, the average number of bugs is described in Table 6.

TABLE 5

| | | | | |
|---|---|---|---|---|
| | Pest-proof coating + | Number of | Expected | |
| Item | LED | bugs | effect | Test conditions |

Location: Jigok-myeon, Seosan-si, South Chungcheong Province, Korea

| | | | | |
|---|---|---|---|---|
| General lighting | Commercially available | About 170 | None | Time: 19:00- |
| | lighting | or more | | 20:30 |
| Invention (pest-proof and | Pest-proof LED + | 3-7 | Very good | Temperature: |
| antimicrobial lighting) | antimicrobial coating | | | 28° C. |
| | lighting | | | Humidity: 66% |
| | | | | Wind: 3 m/s |

Location: Daesan-myeon, Seosan-si, South Chungcheong Province, Korea

| | | | | |
|---|---|---|---|---|
| General lighting | Commercially available | About 190 | None | Time: 19:00- |
| | lighting | or more | | 20:30 |
| Invention (pest-proof and | Pest-proof LED + | 3-6 | Very good | Temperature: |
| antimicrobial lighting) | antimicrobial coating | | | 27° C. |
| | lighting | | | Humidity: 7% |
| | | | | Wind: 5 m/s |

Location: Seongyeon-myeon, Seosan-si, South Chungcheong Province, Korea

| | | | | |
|---|---|---|---|---|
| General lighting | Commercially available | About 150 | None | Time: 19:00- |
| | lighting | or more | | 20:30 |
| Invention (pest-proof and | Pest-proof LED + | 4-8 | Very good | Temperature: |
| antimicrobial lighting) | antimicrobial coating | | | 27° C. |
| | lighting | | | Humidity: 73% |
| | | | | Wind: 4 m/s |

Location: Munsan-eup, Paju-si, Gyeonggi-do, Korea

| | | | | |
|---|---|---|---|---|
| General lighting | Commercially available | About 210 | None | Time: 19:00- |
| | lighting | or more | | 20:30 |
| Invention (pest-proof and | Pest-proof LED + | 4-9 | Very good | Temperature: |
| antimicrobial lighting) | antimicrobial coating | | | 25° C. |
| | lighting | | | Humidity: 86% |
| | | | | Wind: 3 m/s |

Location: Paju-eup, Paju-si, Gyeonggi-do, Korea

| | | | | |
|---|---|---|---|---|
| General lighting | Commercially available | About 220 | None | Time: 19:00- |
| | lighting | or more | | 20:30 |
| Invention (pest-proof and | Pest-proof LED + | 5-8 | Very good | Temperature: |
| antimicrobial lighting) | antimicrobial coating | | | 28° C. |
| | lighting | | | Humidity: 79% |
| | | | | Wind: 5 m/s |

Location: Papyeong-myeon, Paju-si, Gyeonggi-do, Korea

| | | | | |
|---|---|---|---|---|
| General lighting | Commercially available | About 370 | None | Time: 19:00- |
| | lighting | or more | | 20:30 |
| Invention (pest-proof and | Pest-proof LED + | 3-7 | Very good | Temperature: |
| antimicrobial lighting) | antimicrobial coating | | | 30° C. |
| | lighting | | | Humidity: 85% |
| | | | | Wind: 3 m/s |

Location: Jindong-myeon, Paju-si, Gyeonggi-do, Korea

| | | | | |
|---|---|---|---|---|
| General lighting | Commercially available | About 390 | None | Time: 19:00- |
| | lighting | or more | | 20:30 |
| Invention (pest-proof and | Pest-proof LED + | 4-8 | Very good | Temperature: |
| antimicrobial lighting) | antimicrobial coating | | | 29° C. |
| | lighting | | | Humidity: 79% |
| | | | | Wind: 4 m/s |

Location: Jinseo-myeon, Paju-si, Gyeonggi-do, Korea

| | | | | |
|---|---|---|---|---|
| General lighting | Commercially available | About 420 | None | Time: 19:00- |
| | lighting | or more | | 20:30 |
| Invention (pest-proof and | Pest-proof LED + | 4-9 | Very good | Temperature: |
| antimicrobial lighting) | antimicrobial coating | | | 31° C. |
| | lighting | | | Humidity: 89% |
| | | | | Wind: 2.5 m/s |

TABLE 6

| | | Average number of | Expected effect of |
|---|---|---|---|
| Item | | bugs | lighting |
| General lighting | | 265 | None |
| Invention | Pest-proof LED + antimicrobial | 3-6 | Very good |
| | coating lighting | | |

The present invention has been described with reference to the limited embodiments and drawings and the particular details, and it will be understood that the above description has been merely provided for further understanding the present invention, but the present invention is not limited to the embodiments, and those skilled in the art may carry out various changes and modifications from the above-mentioned description.

Accordingly, therefore, the spirit of the present invention will not be determined by the aforementioned embodiments only, and the following claims as well as all modifications or variations belonging to the equivalents of the claims will be within the scope of the invention.

1. A pest-proof and antimicrobial composition comprising:
metal powder, sea marine stone, nanocellulose, and water, wherein
the metal powder includes one or more selected from gold, silver, titanium, copper, zinc, vanadium, iron, platinum, nickel, aluminum, magnesium, and calcium powder, and
the sea marine stone includes 20 to 40 wt % of SiO₂, 10 to 25 wt % of Al₂O₃, 2 to 10 wt % of SnO₂, 2 to 10 wt % of Fe₂O₃, 0.1 to 2 wt % of MgO, 1 to 2 wt % of K₂O, 0.3 to 2 wt % of Na₂O, 20 to 40 wt % of TiO₂, 0.3 to 3 wt % of ZnO, 0.01 to 0.05 wt % of MnO, and 0.0005 to 0.005 wt % of P₂O₅.

2. The pest-proof and antimicrobial composition of claim 1, further comprising:
40 to 60 parts by weight of sea marine stone, 1 to 10 parts by weight of metal powder, and 40 to 60 parts by weight of nanocellulose based on 100 parts by weight of the water.

3. The pest-proof and antimicrobial composition of claim 1, wherein the water is ultrapure or distilled water.

4. The pest-proof and antimicrobial composition of claim 1, further comprising: picaridin.

5. The pest-proof and antimicrobial composition of claim 4, further comprising: 0.01 to 10 parts by weight of picaridin based on 100 parts by weight of the water.

6. The pest-proof and antimicrobial composition of claim 1, wherein the metal powder has an average particle diameter of 1 nm to 200 nm.

7. The pest-proof and antimicrobial composition of claim 1, wherein the marine stone has a powder form and has an average particle size of 1 nm to 200 nm.

8. A pest-proof and antimicrobial lighting comprising: an LED lamp coated with a pest-proof and antimicrobial composition of claim 1.

9. The pest-proof and antimicrobial lighting of claim 8, wherein the LED lamp has a color temperature range of 2,000 K to 6,000 K.

10. The pest-proof and antimicrobial lighting of claim 9, wherein the LED lamp has a color temperature range of 2,000 K to 3,000 K.

11. The pest-proof and antimicrobial lighting of claim 9, wherein the LED lamp emits a light wavelength obtained by removing a wavelength band of 300 nm to 500 nm.

12. The pest-proof and antimicrobial lighting of claim 11, wherein the LED lamp emits the light wavelength of 510 nm to 700 nm.

13. The pest-proof and antimicrobial lighting of claim 9, wherein the LED lamp includes any one selected from a bulb type, a street lamp, a solar street lamp, floodlight, a solar floodlight, a ceiling light, a downlight, a searchlight, a horizon light, a multi-light pendant, a stand light, a full light, a wall lamp, a kitchen lamp, a living room lamp, a flat edge lamp, a square light, a circular room lamp, a cross-line lamp, an I-line lamp, a square sensor lamp, a circular sensor lamp, a circular ceiling downlight, an oval ceiling downlight, an underground lamp, a parking lot lighting lamp, a compatible LED lamp, a PL fixture, a short type ball bulb, a long type ball bulb, a studio button lamp, a square button lamp, a cross lamp, a long stand lamp, a mood lamp, a factory lamp, a desk stand lamp, a slim surface lighting, a bathroom lamp, a sink lamp, a shoe rack lamp a flat slim bezel edge, a square floodlight, a traffic light, a sensor lamp, a ceiling downlight lamp, a recessed floodlight, a signboard lamp, a flat panel lighting, a surface lighting, a ship floodlight, a landscape lighting, a factory floodlight, a tunnel lamp, a waterproof surface lighting flat lamp, an emergency downlight, a gas station LED lighting, an emergency guide lamp, a light for high-temperature and high-humidity environments, an emergency flat lamp, a sports lighting, a floodlight and landscape lamp, a parking lot lamp, a moisture-proof lamp, a parking lamp, a security street lamp, a crosswalk floodlight, a street and garden lamp, a security lamp, a tree light and a car headlight.
